(19) United States
(12) Patent Application Publication
(10) Pub. No.: US 2017/0013227 A1
(43) Pub. Date: Jan. 12, 2017

(54) STANDBY POWER CONTROLLER WITH ENHANCED USE DETECTION

(71) Applicant: Embertec Pty Ltd, Dulwich (AU)

(72) Inventor: Domenico Gelonese, Dulwich (AU)

(21) Appl. No.: 15/205,387

(22) Filed: Jul. 8, 2016

(30) Foreign Application Priority Data
Jul. 9, 2015 (AU) 2015902719

(51) Int. Cl. H04N 5/63; A63F 13/25; A63F 13/235; H04N 5/44

(52) U.S. Cl. CPC H04N 5/63; H04N 5/4403; A63F 13/25; A63F 13/235; H04N 2005/4428

(57) ABSTRACT

A standby power controller removes power from a television when the television is not in use. The television serves as a monitor for a gaming console. The standby power controller includes a gaming console use detector which detects whether the gaming console is in active use. The standby power controller will not remove power from the television while the gaming console use detector detects the gaming console to be in active use.

### FIELD OF THE INVENTION

This invention relates to a standby power controller having the capability to detect use of a gaming console.

### BACKGROUND OF THE INVENTION

The following references to and descriptions of prior proposals or products are not intended to be and are not to be construed as statements or admissions of common general knowledge in the art. In particular, the following prior art discussion does not relate to what is commonly or well known by the person skilled in the art, but may assist in the understanding of the inventive step of the present invention, of which the identification of pertinent prior proposals is but one part.

There is currently world-wide concern about the level of use of electrical energy for both domestic and commercial uses. In part this concern is based on the greenhouse gas production associated with the generation of electrical energy, and the contribution of that greenhouse gas to anthropogenic global warming. There is also a concern for the capital cost involved in building the electricity generating plants and electricity distribution networks required to generate and distribute an increasing amount of electricity.

A significant contributor to household energy use is household audio visual equipment, including devices such as televisions, television decoders, television recorders and sound equipment now found in virtually all homes.

Efforts have been made to reduce or control the use of energy by television receivers and associated audio visual equipment, in particular with the use of standby power controllers, and these have met with considerable success. Attempts have been made to add improved functionality to the basic standby power controller to improve power saving and also to enhance user experience, which is important. One of the greatest barriers to power saving by standby power controllers is user adoption and continued use. Features which address these problems often require user interaction or more sophisticated controls. A particular barrier to the installation and continued use of standby power controllers has been inconvenience to the users of electronic gaming consoles.

### SUMMARY OF THE INVENTION

A preferred version of the invention involves a standby power controller which controls the supply of electricity to a television, wherein the television acts as a monitor for a gaming console, and wherein the standby power controller includes a gaming console use detector which detects that the gaming console is in active use. The standby power controller will not remove the supply of electricity from the television while the gaming console use detector detects the gaming console to be in active use.

Preferably, the gaming console use detector includes a communication detector which detects communication between the gaming console and an associated gaming controller.

Preferably, the communication detector includes a Bluetooth transceiver.

Preferably, the gaming console use detector indicates gaming console use has been detected when communication between the gaming console and the gaming controller has been detected within a selected immediately past time period. Preferably, the selected immediately past time period for detection of gaming console use is about five minutes.

Preferably, a remote control use detector detects use of a remote control associated with the television, whereby the standby power controller will not remove the supply of electricity from the television when remote control use has been detected within a selected immediately past time period. Preferably, the selected immediately past time period for detection of remote control use is about one hour.

The invention also involves a method for reducing energy use in an audio visual environment which includes a gaming console, the method including the steps of providing a switch adapted to remove power from a television when the television is not in use, then wirelessly detecting use of a gaming controller. Where use of the gaming controller has been detected within a selected immediately past time period, the standby power controller will prevent the switch from operating to remove power from the television.

Preferably, the use of the gaming controller is detected by detecting use of a Bluetooth communication link. More preferably, the Bluetooth communication link is provided as a Bluetooth communication link between a gaming console for which the television is functioning as a monitor, and the gaming console's associated gaming controller.

A Remote Control Sensor is preferably provided, and detects use of a remote control associated with equipment in the audio visual environment. Where use of the remote control has been detected within a selected immediately past time period, the switch is prevented from operating to remove power from the television.

Preferably, the Remote Control Sensor is a radio frequency wireless detector able to detect RF4CE based communications. Alternatively, the Remote Control Sensor is a sensor for detecting infra-red communication signals.

The invention also involves a sensor unit for use with a standby power controller including a wireless communication detector which detects communication between a gaming console and an associated gaming controller. The wireless communication detector preferably includes a Bluetooth transceiver, and the sensor unit preferably further includes an infra-red detector for detection of use of a television remote control.

### BRIEF DESCRIPTION OF THE DRAWINGS

The invention will now be described with reference to exemplary versions of the invention in connection with the accompanying drawings, in which:

FIG. 1 illustrates a standby power controller incorporating the invention.

FIG. 2 is a functional block diagram of the operation of a standby power controller incorporating the invention.

FIG. 3 is physical block diagram of an exemplary version of the invention.

### DETAILED DESCRIPTION OF EXEMPLARY VERSIONS OF THE INVENTION

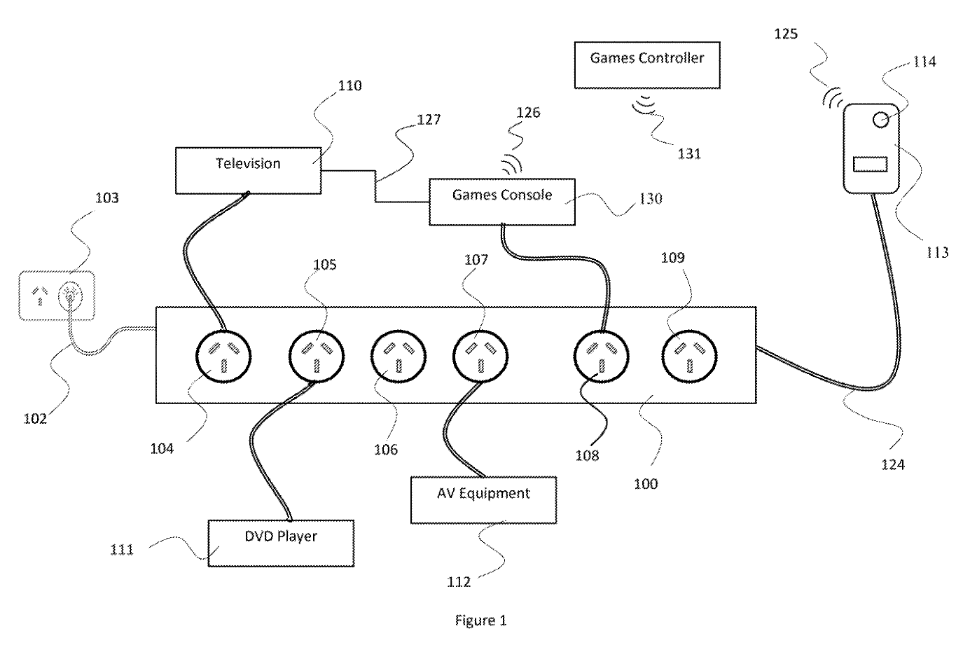

FIG. 1 is a general representation of an installation including a standby power controller (SPC) including the invention, and is illustrative only. It is not intended to limit the number or configuration of continually powered or switched or monitored main outlets, or of communication interfaces or other functional modules.

FIG. 1 shows a representation of a standby power controller (SPC) 100, a device which controls the flow of electrical power to one or more connected appliances such that when one or more, or a particular one, of the connected appliances is in a “standby” state where it is not being used, the electrical power supply to one, all, or selected ones of the connected appliances is interrupted.

The standby power controller (SPC) 100 receives electrical power from a General Purpose Outlet 103 via power cord 102, and includes Monitored and Controlled Outlets 104, 105, 106, 107. The SPC 100 also preferably includes Always On Outlets 108, 109, though these may be absent. In general, any number of Monitored and Controlled Outlets 104, 105, 106, 107 and Always On Outlets 108, 109 may be provided.

Monitored and Controlled Outlets 104, 105, 106, 107 are monitored, either individually, in aggregate, or in subgroups to determine characteristics of the power drawn through the outlets by the connected appliances. The power to the Monitored and Controlled Outlets 104, 105, 106, 107 is controlled by the standby power controller (SPC) 100, and power may be withdrawn from these outlets either individually, in groups, or from all Monitored and Controlled Outlets 104, 105, 106, 107 simultaneously.

Always On Outlets 108, 109 provide power to devices connected to those outlets at all times when power is supplied to the standby power controller (SPC) 100 from the General Purpose Outlet 103.

Monitored and Controlled Outlet 104 supplies electrical power to a television 110. Further Monitored and Controlled Outlets 105, 106, 107 may provide electrical power to other audio-visual equipment, for example, a DVD player 111 and audio equipment 112. A Monitored and Controlled Outlet can be used to power multiple devices from the Outlet using a powerstrip.

In FIG. 1, Always On Outlet 108 provides power for a gaming console 130, though the gaming console 130 may powered from an outlet which is not provided by the standby power controller (SPC) 100. The gaming console 130 is connected to the television 110 by a video connection 127. The video connection 127 allows the gaming console 130 video output to be displayed to a user on the television 110. In FIG. 1, the video connection 127 is a HDMI connection, though any suitable wired or wireless protocol able to carry a video signal may be used.

The gaming console 130 includes a Bluetooth transceiver 126. This provides a data link to a gaming controller 131, which has a Bluetooth transceiver 131. The gaming controller 131 allows a user to provide input to the user interface of a game being presented by the gaming console 130. When the gaming controller 131 is in active use, Bluetooth communications flow between the gaming controller 131 and the gaming console 130. While Bluetooth is contemplated for the illustrated version, any other suitable wireless communication protocol may be used between the gaming console 130 and the gaming controller 131.

The standby power controller (SPC) 100 includes a Sensor Unit 113, which is preferably in data communication with the body of the SPC 100 via cable 124, which may also provide power to the Sensor Unit 113. The cable 124 may be a fixed connection or may be plug connected at one or both ends. Rather than being provided via a cabled connection, the Sensor Unit 13 may be integrated with the SPC 100 body.

Modern television sets and other audio visual equipment, when turned “off” by the remote control, enter a low power “standby” state in which energy is still consumed, although at a significantly lower level that when the device is nominally “on”. When the television 110 or other audio visual equipment is in this standby state it is not in use, and the power supply to it may be cut to save energy, without inconvenience to a user.

It is also the case that television sets may be left on for extended periods when no user is viewing the screen. This may happen when a user falls asleep in front of the television 110, or when a user, particularly a child or a teenager, simply leaves the vicinity of the television 110 without turning the television 110 off. This state may be termed “active standby”. In this state the television 110 is not in use, and the power supply to it may be cut to save energy without inconvenience to a user.

The standby power controller (SPC) 100 may detect that the television 110 has entered a standby state by any convenient means, or combination of means.

The standby power controller (SPC) 100 may include a Power Sensor 201 adapted to sense the power drawn through a Monitored and Controlled Outlet 104, 105, 106, 107. The Power Sensor 201 detects characteristics of the power flow through the outlet. When the characteristic is such as to indicate that the television 110 is in a standby state, the power to the Monitored and Controlled Outlet 104, and hence to the attached television 110 or monitor, is interrupted.

In order to save energy, the standby power controller (SPC) 100 operates to remove the power supply from Monitored and Controlled Outlet 104, and hence from the attached television 110, whenever the television 110 is detected to not be in use. Preferably, the SPC 100 operates to remove power from all of the Monitored and Controlled Outlets 104, 105, 106, 107 together, removing power from all connected audio visual equipment (which is unlikely to be in use if the television 110 is not in use).

In a preferred version, the power drawn through all of the Monitored and Controlled Outlets 104, 105, 106, 107 in aggregate is monitored. Power is only withdrawn when the characteristics of the aggregate monitored power draw indicates that all devices connected to any Monitored and Controlled Outlet is in standby.

The standby power controller (SPC) 100 may include a user interaction sensor to detect that a user is interacting with the audio visual equipment and/or the television 110. The Sensor Unit 113 includes a user interaction sensor in the form of a remote control sensor (infra-red sensor) 114. This sensor 114 receives IR signals from a remote control associated with the television 110 or other connected AV equipment.

It is likely that a user, when actively watching television 110, will periodically use the remote control to change channels, adjust volume, mute commercials, etc. Thus a remote control signal receiver, such as IR sensor 114, can be used as a user interaction (remote control) sensor. If no remote control activity is detected by the IR sensor 114 for a period of time, the assumption may be made that the television 110 is not in use, and the power supply to the Monitored and Controlled Outlet 104, and hence to the television 110, is interrupted. This may be achieved by using a countdown timer which counts a particular time period, for example, by starting from a specific initial value equal to the time period (say one hour) and continuously decrementing from the initial value. Each detected use of the remote control will reset the countdown timer to the initial value. When the countdown time reaches its limit (e.g., zero), there has been no remote control activity for the time period, and the television 110 is assumed to not be in active use and the electricity supply to the Monitored and Controlled Outlet 104, and hence to the television 110, is interrupted. Preferably, power is withdrawn from all Monitored and Controlled Outlets 104, 105, 106, 107, thereby removing power from all connected audio visual equipment which will not be in use if the television 110 is not in use.

A gaming console 130 will often include a hard drive, and may suffer damage or data loss if power is suddenly removed. When a gaming console 130 is shut down by use of its controls, it will perform a shutdown sequence which ensures that hard drives and data are preserved when power is withdrawn. For this reason, in the illustrated example, the gaming console 130 is preferably powered from an Always On Outlet 108 from which the standby power controller (SPC) 100 does not remove power. This means that the power drawn by the gaming console 130 is not monitored.

The television 110 provides the monitor for the gaming console 130. It is undesirable that the television 110 should be shut off when the gaming console 130 is in use. In the absence of any use of an IR remote control while gaming, the countdown timer will reach zero, and power will be withdrawn from the television 110. This will be frustrating for the gamer and will be more likely to lead to the deinstallation of the standby power controller (SPC) 100. The SPC 100 may provide a visual indication that it is about to shut down, allowing the gamer to use the television 110 remote control to provide an IR signal to reset the countdown timer and prevent the television 110 from being shut down. This is likely to be unsatisfactory to many users of gaming consoles. Gaming is an activity which often requires focused attention, and a gamer who is so focused may not be aware of the shutdown indication, or may find the interruption necessary to use an IR remote control unacceptable.

The Sensor Unit 113 includes Bluetooth sensor 125. This sensor 125 detects the Bluetooth communication between the gaming console 130 and the gaming controller 131. The output of the Bluetooth sensor 125 is used to determine the use status of the gaming console 130. Power will only be withdrawn from the Monitored and Controlled Outlets 104, 105, 106, 107, and hence the television 110, when the use status of the gaming console 130 is determined to be other than active use. As in the case of the IR sensor 114, the gaming console 130 will be determined not to be in active use when there is an absence of detected Bluetooth communication for a defined period of time.

Bluetooth communication between the gaming controller 131 and the gaming console 130 will be at least substantially constant while the gaming console 130 is in use. Thus a quite short period of time in which no Bluetooth communication is detected will be sufficient to establish that the gaming console 130 is not in use.

The Bluetooth protocol employs a defined part of the electromagnetic spectrum for its physical communication layer. Accordingly, the Bluetooth sensor 125 may simply detect activity in that part of the spectrum. The standby power controller (SPC) 100 will then infer that the gaming console 130 is in use if any such activity is detected.

Communications protocols other than Bluetooth share the same electromagnetic spectrum with Bluetooth, which may lead to false positive detection where the gaming console 130 is detected to be in use when it is not in fact in use. The Bluetooth sensor 125 may include Bluetooth “sniffer” functionality, allowing positive identification that there is at least a Bluetooth communication link active. The Bluetooth sniffer may further be able to at least partially decode received Bluetooth traffic in order to determine that the traffic is associated with a gaming console 130. The sniffer may allow identification of the type of gaming console 130, or an individual gaming console 130. Where the specific type or specific individual gaming console 130 can be identified, a user, during set-up of the standby power controller (SPC) 100, may identify the type or particular identity of the gaming console 130 to the SPC 100. The SPC 100 will then only indicate detection of Bluetooth activity where the detected Bluetooth communications are from that type or that particular gaming console 130.

The Bluetooth protocol includes the concept of pairing, whereby two Bluetooth devices identify each other and establish a communications link. This link may be encrypted. Thus, the Bluetooth sensor 125 may be a Bluetooth transceiver which is able to pair with the gaming console 130. The standby power controller (SPC) 100 is then able to directly query the gaming console 130 in order to determine the use status of the gaming console 130.

In a situation where it is known that the gaming console 130 will not suffer damage or data loss in the case of the unexpected withdrawal of power, the gaming console 130 may be powered via one of the Monitored and Controlled Outlets 104, 105, 106, 107. In this case, when the television 110 and the gaming console 130 are determined not to be in use, power will also be withdrawn from the gaming console 130, which will save the power drawn by the gaming console 130 while in an unused state.

It may be sufficient to determine that a user is present in the vicinity of the television 110 (e.g., with 3 meters or so of the television 110) in order to decide that the television 110 should not be turned off. Any suitable user presence sensor may be used for determining that a user is present, and thus that power to the television 110 should not be interrupted. These include, without limitation, passive IR sensors, ultrasonic sensors, cameras, any other passive or active movement sensors, and sound detectors.

Whatever means is used to determine that the television 110 is on, but not in use, it is unlikely to be completely free of false positives, that is, determining that the television 110 is in active standby and not in use when the television 110 is in fact in use. If the television 110 is turned off when a user is still watching a program, the user will be irritated. Repeated occurrences are likely to lead to the power control function of the standby power controller (SPC) 100 being bypassed, preventing power savings. Thus, the SPC 100 may include a warning indicator, such as a warning LED. When the SPC 100 determines that the television 110 is in active standby, the warning LED will flash to alert any user to the imminent shutdown of the power to the television 110. In the case where there is a false positive, that is, there is a user watching the television 110, the user may react to observing the flashing of the warning LED by pressing a key on the remote control. The IR signal from the remote control is detected by the IR sensor 114, and the countdown timer is reset, preventing interruption of the power to the television 110. Methods other than a warning LED may be used for warning of imminent shutdown of power to the television 110 may be used, for example, an audible warning tone.

The standby power controller (SPC) 100 may include software allowing control of the warning mechanism, for example, by allowing control of the brightness of the warning LED. It may be possible to set times when the warning should take certain forms. For example, an audible warning may be used at certain times of the day, while the warning LED is used at other times. At still further times, no warning at all may be given.

Devices other than a television 110 may be connected along with a television 110 to the Monitored and Controlled Outlets 104, 105, 106, 107. In this case, the total load of all devices may be monitored for the characteristics indicating that all devices so connected are in a standby or unused state.

A third type of power outlet (not shown) may be provided. This non-monitored, controlled outlet is not monitored by the Power Sensor 201, so the power drawn by any load connected to the non-monitored, controlled outlet does not contribute to the determination that the monitored load is in a standby or unused state. When power is interrupted to the Monitored and Controlled Outlets 104, 105, 106, 107, power is also interrupted to this non-monitored, controlled outlet.

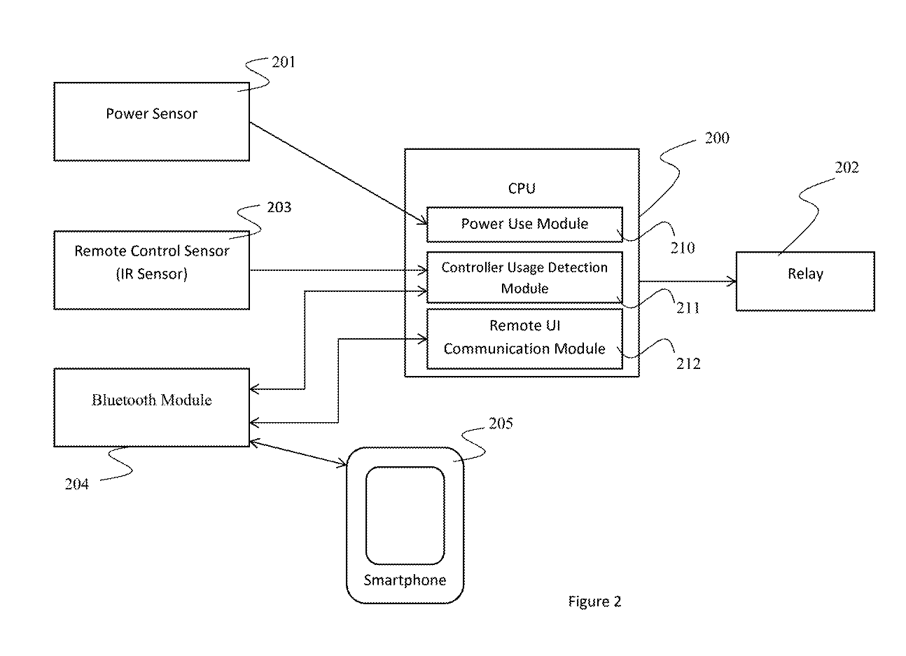

A block diagram of the functions of a standby power controller (SPC) exemplifying the invention is shown in FIG. 2. In use, the SPC operates to provide power to a television. The television also acts as a monitor for a gaming console. A CPU 200 is provided which executes commands to provide the analytical functionality of the standby power controller (SPC). A Power Sensor 201 detects the power drawn by the television. The Power Sensor 201 may monitor the current drawn through the standby power controller (SPC) by the television, or both current and voltage may be monitored, as may phase angle. The output of the Power Sensor 201 is provided to the Power Use Module 210 of the CPU 200.

The Power Use Module 210 analyzes the power draw reported by the Power Sensor 201. The results of this analysis are used to determine the power state of the television. As an example, a significant drop in the magnitude of the power draw may be used to determine that a low power standby mode has been entered. Threshold values of power consumption may be used to determine the power state of the television, with any value below a threshold being used to indicate that the television is in a standby power state. Other characteristics of the power use may be used to determine that the television is not in use. This may be the presence, absence, or a defined pattern of small fluctuations of the power draw.

The CPU 200 controls one or more relays 202. When a determination is made that the television 110 is in a standby state, the CPU 200 controls the relay 202 in order to withdraw power from the television, and optionally from associated equipment.

A Remote Control Sensor 203, preferably an infra-red (IR) sensor which detects use of infra-red remote control devices, is also provided. The Controller Usage Detection Module 211 of the CPU 200 receives data from the Remote Control Sensor 203, indicating use of any IR remote control. When the television is on but no user is actively engaged with the television, the television is said to be in an Active Standby status. In this status the television is using full power and is displaying an image, but is not being “used” by any user.

The Controller Usage Detection Module 211 determines when no IR activity has been detected for a predetermined period. This absence of detection of any use of the remote control by a user is assumed to indicate that no user is actively engaged with the television as a television viewer.

The television acts as the monitor for the gaming console, which may be one of the devices powered through the standby power controller (SPC), or the console may be separately powered. The television will be in use whenever the gaming console is in use, even though no user is acting as a television viewer. This usage as a gaming console monitor does not involve use of any IR device. This means that a determination by the Controller Usage Detection Module 211 that no IR activity has occurred, and hence that there is no television viewer, is insufficient to support the assumption that the television is not in use. If the CPU 200 were to withdraw power from the television based only on the absence of a television viewer, this may lead to an undesired shutdown of the television while it is in use by the gamer. Loss of the display from a game is very annoying for a gamer, and is likely to lead to the uninstallation of the SPC.

In the majority of cases, the game controller communicates with the game console by wireless means. The standby power controller (SPC) includes a controller use detection device, shown in FIG. 2 as a Bluetooth Module 204. The Bluetooth Module 204 is in data communication with the Controller Usage Detection Module 211 of the CPU 200.

The nature of the link between the gaming controller and the gaming console is such that communication is at least substantially continuous while the console is in use. Accordingly, a relatively short period of absence of detection of Bluetooth activity is sufficient to indicate that the gaming console is not in use. When the Controller Usage Detection Module 211 detects that no Bluetooth activity has occurred for a determined length of time, the gaming console is determined to not be in use.

Moreover, when the Controller Usage Detection Module 211 has determined that there has been no IR activity for a suitable period, and no Bluetooth activity for a suitable period, the television is determined to be in an Active Standby mode. When this occurs, the CPU 200 flashes a warning LED or otherwise provides a warning that the television is about to be shut down. This allows a user to make use of an IR remote control in order to prevent the television from shutting down, if in fact there was a user “using” the television who wishes to continue using the television. If IR activity is detected, the shutdown is aborted. If no IR activity is detected in response to the warning, the power to the television is interrupted.

While power to the television is interrupted, the Controller Usage Detection Module 211 continues to monitor IR activity. When the Controller Usage Detection Module 211 determines that IR activity has been detected, the CPU 200 operates the relay 202 and thus power is restored to the television.

In a preferred version, when the power to the television is in the interrupted state, the standby power controller (SPC) 100 will return power to the television when any IR activity is detected. In an alternative version, the SPC 100 may require that the received IR signal is identified as an “ON” command for the television before returning power to the television. This reduces “false positives” where the SPC 100 reacts to an IR source other than the user attempting to turn the television on.

The CPU 200 may be programmed to keep track of the power consumption of the monitored load, both when the load is using full power and when it is in a low power standby state. Information concerning the number of times the power to the load is interrupted may be recorded. Whether the power was interrupted because the television was in a low power standby mode, or because the television was determined to not be in use, may also be recorded. This data may be used to calculate or estimate the energy savings achieved by the standby power controller (SPC) 100.

The CPU 200 includes a Remote User Interface Communication Module 212, which is in communication with a transmitter or transceiver for communication with an external display device. Preferably, this transceiver is the Bluetooth Module 204. The Bluetooth Module 204 is in data communication with a Remote User Interface Display 205, a processing and display device capable of running a user interface program which is adapted to display and operate a user interface for the standby power controller (SPC). In FIG. 2, the Remote User Interface Display 205 is depicted as a smartphone, though other devices such as a tablet computer, a laptop computer, or a desktop computer. A dedicated Remote User Interface Display device may also be provided.

The standby power controller (SPC) may communicate the calculated or estimated energy savings to the Remote User Interface Display 205 for display on the user interface. Alternatively, the SPC may communicate the raw data from the Power Sensor 201 and the Remote Control Sensor 203, along with the timing of the relay control activity, to the Remote User Interface Display 205. The user interface program may then use this data to calculate energy savings for display to a user, and may process the data for display to the user in any convenient manner. Complete information concerning the operation of the SPC 100 may be communicated to the Remote User Interface Display 205 for storage and analysis. This data and the results of analysis may be communicated by the Remote User Interface Display 205 to third parties.

The user interface of the Remote User Interface Display 205 may be used to control the standby power controller (SPC). The value of the predetermined period which must elapse before the SPC concludes that the television is not in use may be changed temporarily or permanently. That is, the threshold time of no detection of IR signals before the SPC decides that the television is in Active Standby may be set and altered from the user interface.

A major cause of failure to save power by standby power controllers (SPCs) is de-installation when a user finds the action of the SPC intrusive or annoying, with the user simply removing the SPC and preventing any energy savings. A major cause of this failure is the detection of Active Standby in, and subsequent cutting of power to, the television which is in use.

The standby power controller (SPC) may also report the frequency of use of the IR remote control to the user interface program. The user interface program may also collect information on how often and at what times the user uses the remote control to prevent the SPC removing power from the television after a warning has been given. These are occasions when the SPC has determined incorrectly that the television is in Active Standby when a user is still actively watching the television. This information may be used to determine a more accurate pattern which indicates that the television is in fact in Active Standby, allowing less occasions where the SPC attempts to (or does) cut power to a television in active use. Improvements in the determination of Active Standby reduce de-installation.

The user interface may present information about the use of IR, the detection of gaming console use, and correct and incorrect determination of Active Standby. Where this information shows that incorrect determinations are rare, user satisfaction with the standby power controller (SPC) is likely to be improved, leading to lower de-installation rates.

The user interface may allow user variation of a variety of operational parameters. Where threshold values of power consumption are used, these may be changed by a user from the user interface on the Remote User Interface Display 205. In an version where the warning mechanism is controllable, the user interface on the Remote User Interface Display 205 may allow control of (for example) the brightness of a warning LED, the volume of an audible warning, and times when the flashing LED, the audible warning, and no warning should be used.

The user interface allows information collected by the standby power controller (SPC) to be displayed to a user. Where the SPC monitors the voltage and/or frequency of the incoming electricity supply, this information may be displayed to a user. Any parameters of the incoming electricity supply monitored by the SPC may be reported to the user interface program. These may be compared with pre-set values, for example, the limits set for these parameters by a regulator, to report on the performance and quality of the incoming electricity supply.

The user interface may allow the user to control the relay in the standby power controller (SPC) directly, turning the switched outlets on and off independently of the determined power and usage state of the television.

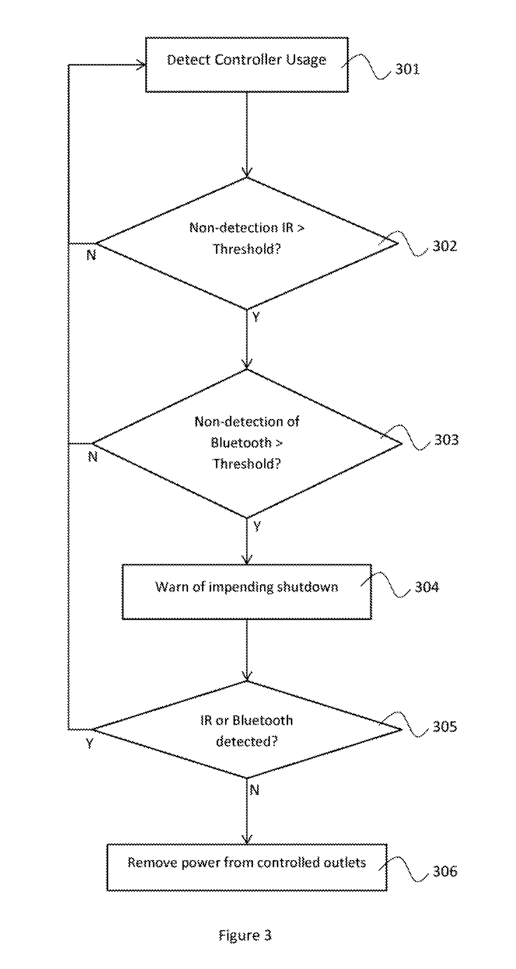

FIG. 3 is a flowchart illustrating the way in which the standby power controller (SPC) of the invention saves energy which would otherwise be wasted in keeping a television operating in an Active Standby mode, while avoiding interference with a gamer's television use. The flowchart illustrates only that subset of the SPC operation related to Active Standby.

At 301, the standby power controller (SPC) acts to monitor usage of control devices associated with the electrical devices which are powered through the Monitored and Controlled Outlets of the SPC. This may include monitoring for IR, RF, or other signals from television or other remote control devices associated with electrical devices connected to the Monitored and Controlled Outlets. The detection of control device usage at 301 includes detection of use of a controller for a gaming console associated with a television powered from one of the Monitored and Controlled Outlets of the standby power controller (SPC). This detection may be by detection of Bluetooth communications, or detection of any other form of communication between the gaming console and the gaming controller.

At 302, the standby power controller (SPC) checks whether communication with a remote control device has not been detected for a period greater than the period determined to be sufficient to indicate that the television is not being actively viewed. Where the period of non-detection of remote control activity is less than the pre-determined period, the SPC continues to monitor for control device usage at 301.

Where the non-detection period exceeds the pre-determined period, the standby power controller (SPC) checks at 303 whether communication with a gaming controller has been detected within a period determined to be sufficient to indicate that a gaming console is not in use. In general, this period will be much less than the period determined to be sufficient to indicate that the television is not being actively viewed. Where the period of non-detection of gaming controller activity is less than the pre-determined period, the SPC continues to monitor for control device usage at 301.

Where the non-detection period exceeds the pre-determined period, the standby power controller (SPC) will warn of impending shutdown of the television at 304. This warning continues for a predefined period sufficient to allow a user to abort the shutdown by operating a remote control device. The SPC continues to monitor for controller activity at 305 while the warning is current.

If no controller operation is detected, the standby power controller (SPC) will cut power to the controlled outlets of the SPC at 306, thus removing power from the television and such other devices deemed not to need power when the television is not operating.

Where reference has been made to infra-red remote controls and corresponding infra-red sensors, it should be understood that any form of remote controls and corresponding sensors, including (for example) radio frequency remote controls, may be employed. Similarly, where reference has been made to Bluetooth controllers and corresponding Bluetooth sensors, it should be understood that any form of controller communication technology and corresponding sensors, including (for example) wi-fi controllers, may be employed.

The invention is not limited to the exemplary versions of the invention described above, but rather is intended to be limited only by the claims set out below. Thus, the invention encompasses all different versions that fall literally or equivalently within the scope of these claims.

What is claimed is:

1. A standby power controller adapted to control the supply of electricity to a television which acts as a monitor for a gaming console, the standby power controller:
a. including a gaming console use detector adapted to detect that the gaming console is in active use,
b. being adapted to remove electricity supply to the television upon the occurrence of a predefined condition, unless the gaming console use detector detects that the gaming console is in active use.

2. The standby power controller of claim 1 further including at least one of:
a. a remote control detector adapted to detect remote control usage, and
b. a user presence detector adapted to detect the presence of a user in the vicinity of the standby power controller,
wherein the standby power controller is further adapted to not remove electricity supply to the television if either of:
(1) the remote control detector detects remote control usage during a preceding predefined remote usage time, or
(2) the user presence detector detects the presence of a user in the vicinity of the standby power controller during a preceding predefined presence time.

3. The standby power controller of claim 2 wherein the standby power controller is adapted to remove electricity supply to the television:
a. if remote control usage has not been detected during the preceding predefined remote usage time,
b. unless the gaming console use detector detects that the gaming console is in active use.

4. The standby power controller of claim 1:
a. further including a remote control detector adapted to detect remote control usage associated with the television,
b. wherein the standby power controller is adapted to not remove electricity supply to the television when remote control usage has been detected during a preceding predefined remote usage time.

5. The standby power controller of claim 4 wherein the remote control detector is an infra-red sensor adapted to detect infra-red communication signals.

6. The standby power controller of claim 4 wherein the remote control detector is a radio frequency sensor adapted to detect RF4CE based communications.

7. The standby power controller of claim 1 wherein the gaming console use detector includes a wireless communications detector adapted to detect communication between the gaming console and an associated gaming controller.

8. The standby power controller of claim 7 wherein the wireless communications detector includes a Bluetooth transceiver.

9. The standby power controller of claim 7 wherein the gaming console use detector indicates gaming console use has been detected when communication between the gaming console and the gaming controller has been detected within a preceding predefined controller usage time.

10. A method for controlling the supply of electricity to a television which acts as a monitor for a gaming console, the method including the steps of:
a. providing a standby power controller adapted to remove power from a television when the television is not in use;
b. detecting via the standby power controller whether the gaming console is in active use;
c. if use of the gaming console has been detected within a preceding predefined controller usage time, preventing the standby power controller from removing power from the television.

11. The method of claim 10 wherein the step of detecting whether the gaming console is in active use includes detecting use of a gaming controller configured to communicate with the gaming console.

12. The method of claim 10 wherein the step of detecting whether the gaming console is in active use includes detecting use of a Bluetooth communication link.

13. The method of claim 10 wherein the step of detecting whether the gaming console is in active use includes detecting use of a Bluetooth communication link between the gaming console and a gaming controller configured to communicate with the gaming console.

14. The method of claim 10 further including the steps of:
a. providing a remote control detector adapted to detect remote control usage, and
b. if remote control usage has been detected during a preceding predefined remote usage time, preventing the standby power controller from removing power from the television.

15. The method of claim 12 wherein the remote control detector is a sensor adapted to detect infra-red communication signals.

16. The method of claim 12 wherein the remote control detector is a radio frequency sensor adapted to detect RF4CE based communications.

17. A sensor unit for use with a standby power controller, the sensor unit including a wireless wireless communications detector adapted to detect communication between a gaming console and an associated gaming controller.

18. The sensor unit of claim 17 wherein the wireless communications detector includes a Bluetooth transceiver.

19. The sensor unit of claim 17 further including an infra-red sensor adapted to detect infra-red communication signals.
